(19) United States
(12) Patent Application Publication
(10) Pub. No.: US 2004/0095443 A1
(43) Pub. Date: May 20, 2004

(54) Ink cartridge for printer

(76) Inventor: Tsong-Maw Chen, Taipei (TW)

Correspondence Address: Tsong-Maw Chen, PO Box 82-144, Taipei, TW

(21) Appl. No.: 10/293,276

(22) Filed: Nov. 14, 2002

(51) Int. Cl. B41J 2/175

(52) U.S. Cl. 347/86

(57) ABSTRACT

An ink cartridge for an inkjet printer is comprised of a cartridge including a box and a lid containing an ink outlet port adapted to a carrier in the printer and an ink porch the cartridge characterized by that a porch opening is air-tightly integrated to the top of the ink outlet port for consistent ink delivery and minimized residual ink.

### BACKGROUND OF THE INVENTION

(a) Field of the Invention

The present invention is related to an ink cartridge for an inkjet printer, and more particularly to one that achieves consistent ink delivery and minimized level residual ink.

(b) Description of the Prior Art

As illustrated in FIG. 1 of the accompanying drawings of the present invention, an ink cartridge of the prior art is essentially comprised of a cartridge adapted to a carrier of the printer and a sponge (1) sealed in the cartridge. Wherein, a lid (2) containing multiple air ports and a box (3) containing an ink outlet port is integrated to the cartridge by welding means, and then a plastic film (4) is stick to seal tip those air ports. However, according to long time experience and observation, the prior art is found with the following flaws and inconveniences: firstly, given with the ink storage and utility, the sponge (3) in the cartridge occupies a certain space that would be otherwise used for ink fill and the absorption of the sponge (3) results in extra consumption of ink; secondly, whereas the prior art operates by introducing negative pressure through those multiple air ports, the general structure of the cartridge is comparatively complicate to make it difficult to effectively reduce production cost, the user often forgets to tear up the plastic film immediately before loading the ink cartridge, and the risk of plugged ink nozzle by dust particles in the air brought into the cartridge through those multiple air ports; and thirdly, ink seepage may take place due to poor seam between the lid and the box. Therefore, improvements to the prior art are required to provide an ink cartridge that is compact, free of ink seepage, fully utilizing the ink fill space and lower the level of residual ink.

### SUMMARY OF THE INVENTION

The primary purpose of the present invention is to provide an improved structure of an ink cartridge for an ink-jet printer essentially comprised of a box and a lid containing an ink outlet port adapted to a carrier in the printer and an ink porch the cartridge characterized by that a porch opening is air-tightly integrated to the top of the ink outlet port for consistent ink delivery and minimized residual ink.

Another purpose of the present invention is to provide an improved structure of an ink cartridge for an inkjet printer; wherein, the box is segregated with two or more than two compartments, an ink outlet port is each assigned to each compartment and an ink porch is connected to the top of each ink outlet port to adapt to the application of the existing color ink cartridge.

Another purpose yet of the present invention is to provide an improved structure of an ink cartridge for an inkjet printer; wherein, a filtration film is stick to cover up the top of the ink outlet port to prevent the ink nozzle of the printer from being plugged.

Another purpose yet of the present invention is to provide an improved structure of an ink cartridge for an ink-jet printer; wherein, a soft conduit in proper length is used to connect between the ink porch and the outlet port of the lid so that the ink porch is not subject to the limitation by the volume of the box when installed in the printer to provide long term ink supply, thus to save the user costs required for replacing the cartridge.

The present invention offers the following advantages by achieving those purposes described above:

1. A compact structure. No air ports are required to be provided on the wall of the box, thus to eliminate the possibly plugged nozzle of the printer by airborne particles.

2. No more sponge in the box is required so to relatively promote ink storage and eliminate extra consumption of ink by the sponge.

3. Since the ink porch is air-tightly packed inside the box, seepage or color mix, particularly in case of a color ink cartridge, due to poor sealing at where the lid joins the edge of the box is prevented.

4. The porch shrinks as the ink inside it is consumed due to negative pressure to deliver the ink and the shrinkage helps minimize residual ink.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a structure of an ink cartridge of the prior art.

FIG. 2 is a front view of a section of the present invention before being filled up with ink.

FIG. 3 is a side view of a section of the present invention after having been filled up with ink.

FIG. 4 is a schematic view showing a local part of a filtration film provided at the top of an ink outlet port of the present invention.

FIG. 5 is a schematic view showing that the present invention is in use.

FIG. 6 is a schematic view showing multiple compartments of the present invention to contain ink porches.

FIG. 7 is a schematic view showing that a conduit is provided between the ink porch and the ink outlet port of the cartridge of the present invention.

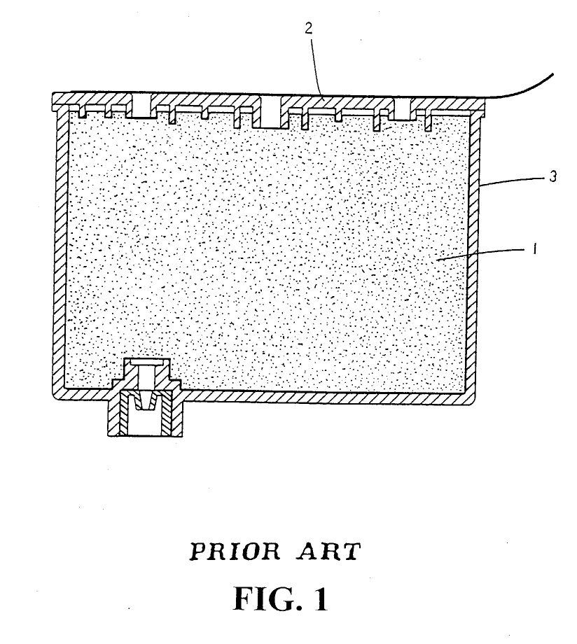

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

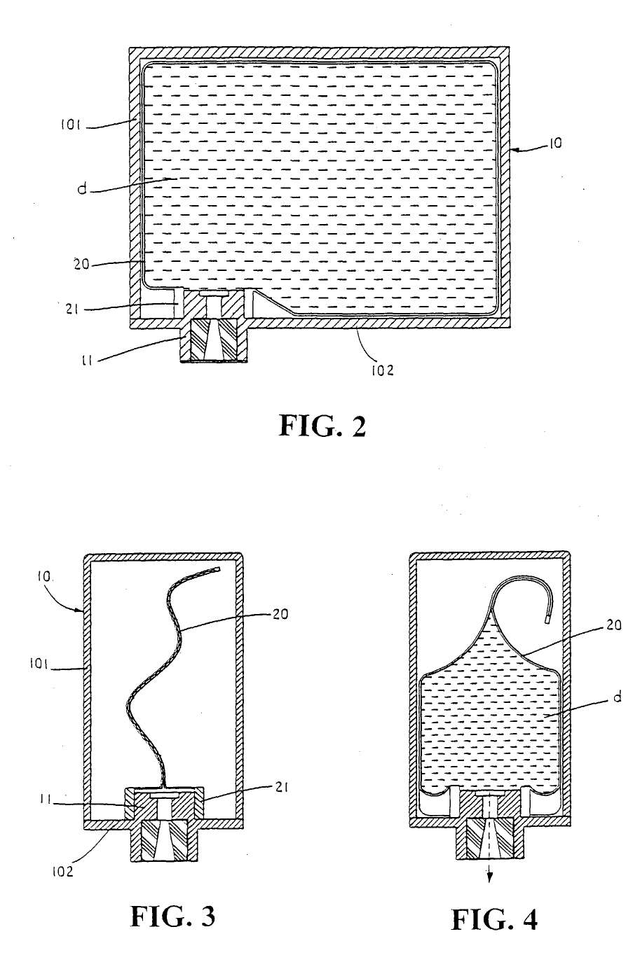

Referring to FIGS. 2 and 3, a preferred embodiment of the present invention is essentially comprised of a cartridge (10) including a box (101) and a lid (102) that can be adapted to a carrier of an ink-jet printer, and an ink porch (20) packed in the cartridge (10). Wherein, an ink outlet port (11) is provided to the lid (102) and an opening (21) is provided to the porch (2) and air-tightly integrated to the top of the ink outlet port (11) in the lid (102). As illustrated in FIGS. 3 and 4, the porch (20) shrinks as ink (d) is consumed due to a negative pressure generated when the ink (d) is delivered by absorption until the ink (d) is fully consumed so to minimize the level of the residual ink.

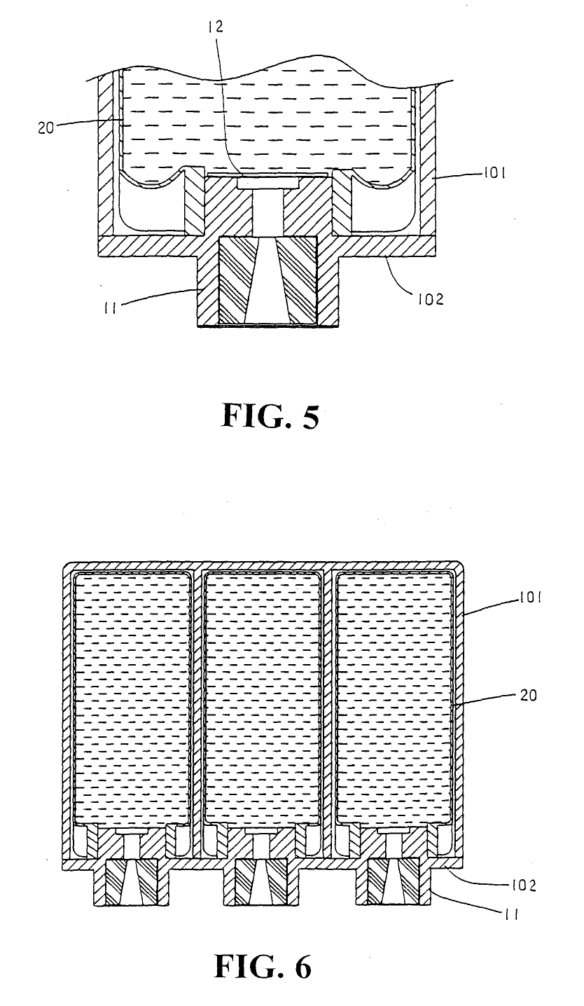

Now referring to FIG. 5 for another preferred embodiment of the present invention; wherein, a filtration film (12) is stick to the top edge of the ink outlet port (1) in the lid (102) to prevent a nozzle of the printer from being plugged. As illustrated in FIG. 6, the box (101) is segregated into two or more than two compartments and one ink outlet port (11) in the lid (102) is assigned to each compartment and each outlet port (11) is connected to one porch (20) to adapt to the application of a color ink cartridge.

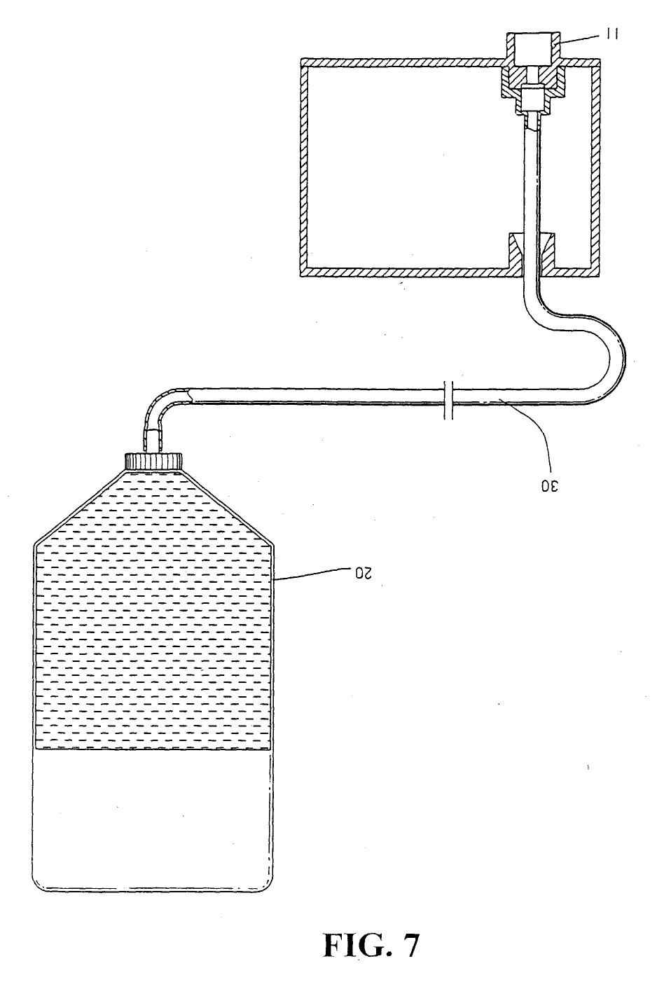

As illustrated in FIG. 7 for another preferred embodiment yet of the present invention; wherein, a soft conduit (30) is connected through both of the porch (20) and the outlet port (11) in the lid (102) in a length merely allowing the cartridge (10) to slide in the printer, so that the porch (20) may be externally extended from the printer for increased volume to continuously supply the ink.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of an ink cartridge for an ink-jet printer is essentially comprised of a box and a lid containing an ink outlet port adapted to a carrier in the printer and an ink porch the cartridge characterized by that a porch opening is air-tightly integrated to the top of the ink outlet port for consistent ink delivery and minimized residual ink.

2. An improved structure of an ink cartridge for an ink-jet printer as claimed in claim 1; wherein the box is segregated with two or more than two compartments, an ink outlet port is each assigned to each compartment and an ink porch is connected to the top of each ink outlet port to adapt to the application of the existing color ink cartridge.

3. An improved structure of an ink cartridge for an ink-jet printer as claimed in claim 1; wherein a filtration film is stick to cover up the top of the ink outlet port.

4. An improved structure of an ink cartridge for an ink-jet printer as claimed in claim 1; wherein a soft conduit in proper length is used to connect between the ink porch and the outlet port of the lid allowing the porch to be externally extended from the printer for increased volume to continuously supply the ink.
